(19) United States
(12) Patent Application Publication
(10) Pub. No.: US 2025/0385470 A1
(43) Pub. Date: Dec. 18, 2025

(54) CONNECTOR

(71) Applicant: PHOENIX CONTACT ASIA-PACIFIC (NANJING) CO., LTD., Nanjing (CN)

(72) Inventors: Miao ZHANG, Nanjing (CN); Fengchun ZHOU, Nanjing (CN)

(21) Appl. No.: 19/303,587

(22) Filed: Aug. 19, 2025

Related U.S. Application Data
(63) Continuation of application No. PCT/CN2024/077871, filed on Feb. 21, 2024.

(30) Foreign Application Priority Data
Feb. 27, 2023 (CN) 202310171790.9

(51) Int. Cl. H01R 13/631; H01R 13/52

(52) U.S. Cl. CPC H01R 13/6315; H01R 13/5202

(57) ABSTRACT

This application relates to the technical field of electrical device, and discloses a connector including a first plug core and a second plug core. The first plug core includes a first body and a guiding shell. The guiding shell is arranged in the first body. A female barrel for the insertion of a male pin is arranged in the guiding shell. The second plug core includes a second body and an assembly shell. The assembly shell is arranged in the second body and is configured to plug and match with the guiding shell. A male barrel for the plugging and matching with the female barrel is arranged in the assembly shell.

### CROSS-REFERENCE TO RELATED APPLICATIONS

This application is a continuation application of International Application No. PCT/CN2024/077871, filed on Feb. 21, 2024, which claims priority to Chinese Patent Application No. 202310171790.9, filed on Feb. 27, 2023, both of which are incorporated herein by reference.

### TECHNICAL FIELD

This application relates to the technical field of electrical device, and particularly, to a connector.

### BACKGROUND

As a conductive structure between two devices or systems, a connector plays an important role in terms of current or signal transmission. For example, energy storage battery packs are connected by a plug-in connection which generally includes two ends respectively, with one end fixedly arranged on a mounting plate of the battery packs and the other end functioning as a floating end. The two ends are plugged together to establish an electrical connection between the battery packs.

To ensure smooth plug, guiding structures, such as guiding posts and guiding holes, are additionally provided on both sides of a plug core to reduce the likelihood of misalignment during the plug of two devices. However, since the battery pack is relatively heavy and cannot be installed in a perfectly vertical orientation during assembly, an impact force may occur when the guiding posts are inserted into the guiding holes, causing the guiding posts to break and resulting in guiding failure.

### SUMMARY

An objective of the present disclosure is to provide a connector that solves the problem in the prior art where, due to the relatively heavy weight of the battery pack and the inability to achieve perfectly vertical installation during assembly, an impact force may occur when the guiding posts are inserted into the guiding holes, causing the guiding posts to break and resulting in guiding failure.

To this end, the present disclosure adopts the following technical solution:

A connector includes a first plug core and a second plug core. The first plug core is configured to connect to a first device. The second plug core is configured to connect to a second device. The first plug core includes a first body and a guiding shell. The guiding shell is arranged in the first body. A female barrel for the insertion of a male pin is arranged in the guiding shell. The second plug core includes a second body and an assembly shell. The assembly shell is arranged in the second body and is configured to plug and match with the guiding shell. A male barrel for the plugging and matching with the female barrel is arranged in the assembly shell.

Optionally, a cross-sectional area of the assembly shell is larger than a cross-sectional area of the guiding shell, and a guiding gap for the insertion of the guiding shell is formed between an inner side of the assembly shell and the male barrel. An inner side wall of the assembly shell is in sliding fit with an outer side wall of the guiding shell.

Optionally, a guiding slope in sliding match with the assembly shell is provided on the outer side wall of the guiding shell.

Optionally, the outer side wall of the guiding shell is provided with a plurality of grooves, and guiding ribs are formed between two adjacent grooves.

Optionally, the inner side wall of the assembly shell is provided with an assembly slope in sliding match with the guiding shell.

Optionally, a sealing groove for installing a sealing ring is provided in the outer side wall of the guiding shell. The sealing ring abuts against the inner side wall of the assembly shell to seal a gap between the assembly shell and the guiding shell.

Optionally, the first body is integrally formed with the female barrel, and the second body is integrally formed with the male barrel.

Optionally, the first plug core is configured to float relative to the first device within a predetermined clearance range, the predetermined clearance being ±3.2 mm.

### BRIEF DESCRIPTION OF THE DRAWINGS

FIG. 1 is a schematic diagram of a structure of a connector according to a first embodiment of the present disclosure;

FIG. 2 is a sectional view of a connector according to a first embodiment of the present disclosure;

FIG. 3 is a schematic diagram of a structure of a first body of a connector according to a first embodiment of the present disclosure;

FIG. 4 is a schematic diagram of a structure of a second body of a connector according to a first embodiment of the present disclosure.

### DETAILED DESCRIPTION OF THE PREFERRED EMBODIMENTS

Below, the present disclosure will now be described in further detail with reference to the accompanying drawings and embodiments. It can be understood that the specific embodiments described herein are provided only for illustrative purposes and are not intended to limit the present disclosure. Additionally, it should be noted that for the sake of clarity, only parts relevant to the present disclosure are shown in the accompanying drawings, rather than the entire structure.

In the description of the present disclosure, unless expressly defined or limited otherwise, the terms “connect”, “engage”, and “secure” should be broadly construed broadly to include: fixed connections, detachable connections, or integral formation; mechanical connection or electrical couplings; direct connection or indirect connections via an intermediate medium; and can be a physical connection between two components or interaction relationships between two components. For ordinary technical personnel in this field, the specific meanings of the above terms in the present disclosure should be interpreted according to their contextual usage herein.

In the present disclosure, unless expressly defined or limited otherwise, a first feature being above or below a second feature may include direct contact between the first and second features or may include contact through another feature between the first and second features instead of direct contact. Furthermore, the first feature being “above”, “over”, and “on” the second feature includes the first feature being directly above or diagonally above the second feature or simply indicating that the first feature is at a higher level than the second feature. The first feature being “below”, “under”, and “underneath” the second feature includes the first feature being directly below or diagonally below the second feature or simply indicating that the first feature is at a lower level than the second feature.

In the description of this embodiment, the terms such as “up”, “down”, “right” refer to the orientations or position relationships shown in the accompanying drawings. These terms are used solely for descriptive convenience and to simplify operational explanations, and do not imply that the referenced device or component must maintain a particular orientation or be constructed and operated in a specific orientation. Therefore, these terms should not be understood as a limitation of the present disclosure. In addition, these terms should not be construed as limiting the scope of this application. Additionally, the terms “first” and “second” are used only for descriptive distinction and carry no special significance.

The embodiment of the present disclosure provides a connector that does not require a separately guiding structure. Instead, plug cores can be plugged and matched with each other by the guide of bodies of the connector. As a result, an overall size of the connector is reduced, and the amount of material used is correspondingly decreased, thereby not only lowering the production cost of the connector but also improving material utilization.

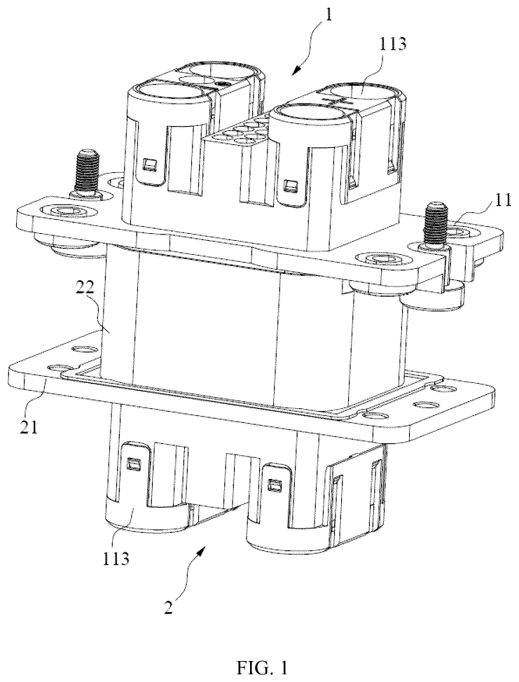

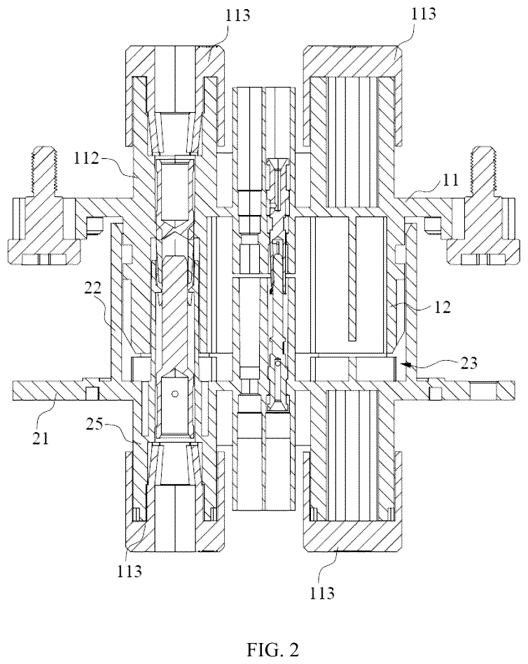

Referring to FIG. 1 and FIG. 2, the connector includes a first plug core 1 and a second plug core 2. The first plug core 1 is configured to connect to the first device, and the second plug core 2 is configured to connect to the second device. The first plug core 1 includes a first body 11 and a guiding shell 12. The guiding shell 12 is arranged in the first body 11, and a female barrel 112 for the insertion of the male pin is arranged in the guiding shell 12. The second plug core 2 includes a second body 21 and an assembly shell 22. The assembly shell 22 is arranged in the second body 21 and is plugged and matched with the guiding shell 12. A male barrel 25 that is plugged and matched with the female barrel 112 is arranged in the assembly shell 22.

Specifically, the first plug core 1 is connected to the first device by a plurality of fasteners. The first plug core 1 is configured to translate and float relative to the first device so as to align with the second plug core 2. The guiding shell 12 is formed by protruding from a side of the first body 11 away from the first device and extending in a direction away from the first device. A cross-section of the guiding shell may be polygonal, such as rectangular, or curved, such as circular. One end of the female barrel 112 passes through the first body 11 and extends into the guiding shell 12, while the other end is arranged in the first device and electrically connected to the circuitry in the first device.

The second plug core 2 is fixedly connected to the second device by a plurality of fasteners. An eccentric screw hole can be arranged in the second plug core 2 to prevent reverse installation orientation The assembly shell 22 is formed by protruding from a side of the second body 21 away from the second device and extending in a direction away from the second device. A shape of the assembly shell 22 is designed according to a shape of the guiding shell 12, and the assembly shell can be in guide fit with the guiding shell 12. The way in which the male barrel 25 is arranged is the same as that of the female barrel 112 and will not be redundantly described herein.

When the connector is installed, the first plug core 1 is first aligned with the second plug core 2, and then the guiding shell 12 is plugged with assembly shell 22. Under a guiding action of the guiding shell 12 and the assembly shell 22, the first body 11 can be plugged and matched with the second body 21. Therefore, when the first body 11 is plugged with the second body 21, the plugging is quickly completed by using the guiding relationship between the guiding shell 12 and the assembly shell 22. The guiding shell 12 and the assembly shell 22 can be respectively formed by protruding extensions of the first body 11 and the second body 21 themselves, so that the first plug core 1 and the second plug core 2 do not need to be provided with a separate guiding structure. Thereby, the guiding effect of the guiding structure can be effectively ensured, reducing the likelihood of guiding function failure, which is beneficial for ensuring the stable performance of the connector and prolonging its service life.

Referring to FIG. 2, in some embodiments of the present disclosure, a cross-sectional area of the assembly shell 22 is greater than a cross-sectional area of the guiding shell 12, and a guiding gap 23 for the insertion of the guiding shell 12 is formed between an inner side of the assembly shell 22 and the male barrel 25. An inner side wall of the assembly shell 22 is in sliding fit with an outer side wall of the guiding shell 12.

Specifically, a cross-section of the assembly shell 22 and a cross-section of the guiding shell 12 are both rectangular. A length and width of the inner side of the assembly shell 22 are both greater than a length and width of the outer side of the guiding shell 12. The male barrel 25 is arranged at the middle portion of the assembly shell 22, and an end surface of the male barrel 25 can be flush with an end surface of the assembly shell 22. A distance is maintained between the male barrel 25 and the inner side wall of the assembly shell 22 to form the above-mentioned guiding gap 23. Further, an end surface of the female barrel 112 can be flush with an end surface of the guiding shell 12, so that the guiding shell 12 can be fully inserted into the assembly shell 22.

By forming the guiding gap 23, when the female barrel 112 is plugged with the male barrel 25, the guiding shell 12 is inserted into the guiding gap 23 in the assembly shell 22. The outer side wall of the guiding shell 12 is in sliding fit with the inner side wall of the assembly shell 22, thereby producing a guiding effect. As the guiding shell 12 is gradually inserted into the assembly shell 22, the plugging of the male barrel 25 with the female barrel 112 can be completed smoothly.

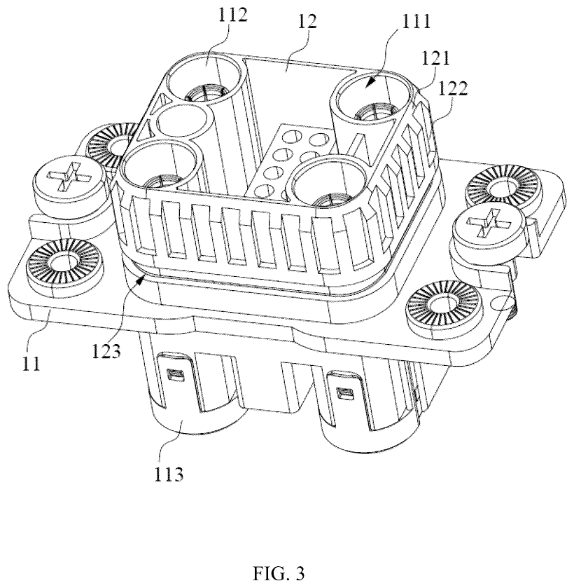

Referring to FIG. 3, in some embodiments of the present disclosure, the outer side wall of the guiding shell 12 is provided with a guiding slope 121 in sliding fit with the assembly shell 22.

Specifically, an open end of the guiding shell 12 is chamfered to form the guiding slope 121. The guiding slope 121 is oriented towards the assembly shell 22. An inclination angle of the guiding slope can be designed depending on requirements of plugging and matching, such as 45° or 30°, etc.

By arranging the guiding slope 121, the cross-sectional area of one end where the guiding shell 12 is inserted into the assembly shell 22 can be reduced, thereby facilitating the insertion of the guiding shell 12 into the assembly shell 22. At the same time, the guiding slope 121 can also play a guiding role. When the guiding shell 12 is plugged with the assembly shell 22, the guiding slope 121 can be in sliding fit with the inner side wall of the assembly shell 22, so that the guiding shell 12 can smoothly slide into the assembly shell 22.

Referring to FIG. 3, in some embodiments of the present disclosure, the outer side wall of the guiding shell 12 is provided with a plurality of grooves at intervals, and guiding ribs 122 are formed between two adjacent grooves.

Specifically, the grooves extend vertically, and the plurality of grooves are equidistantly distributed along a circumference of the guiding shell 12 to form a plurality of guiding ribs 122. One end of the guiding rib 122 adjacent to the guiding slope 121 can be connected to the guiding slope 121 and is also provided with a slope with a corresponding inclination angle. The guiding rib 122 can also be secured to the outer side wall of the guiding shell 12 by adhesion or welding. In addition, an annular groove is formed separately on the outer side wall of the guiding shell 12 for installation of the guiding rib 122.

By arranging the grooves, the material used for manufacturing the guiding shell 12 can be effectively reduced, and the guiding rib 122 can effectively fill a gap formed when the guiding shell 12 is inserted into the guiding gap 23, so that the guiding shell 12 and the assembly shell 22 are stably plugged and not easy to shake. At the same time, the arrangement of the guiding rib 122 can also improve the strength of the guiding shell 12, and reduce the possibility that the guiding shell 12 is damaged in the process of plugging the guiding shell 12 and the assembly shell 22.

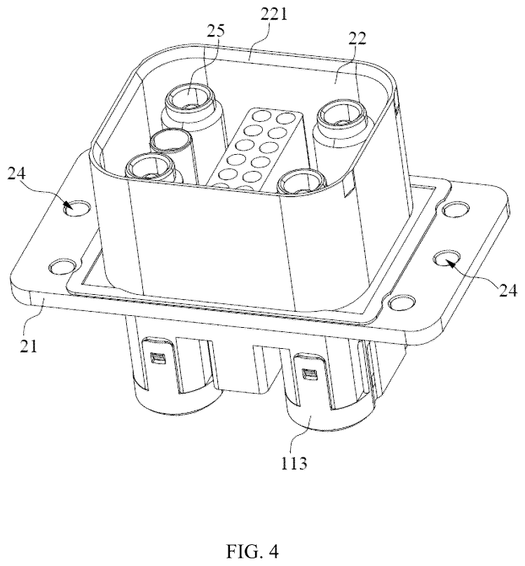

Referring to FIG. 4, in some embodiments of the present disclosure, the inner side wall of the assembly shell 22 is provided with an assembly slope 221 in sliding fit with the guiding shell 12.

Specifically, the inner side wall of the assembly shell 22 is chamfered to form an assembly slope 221. An inclination angle of the assembly slope can be designed according to the guiding slope 121 of the guiding shell 12, so that the assembly slope 221 can be matched with the guiding slope 121. By arranging the assembly slope 221, an opening area of the assembly shell 22 is increased, facilitating smooth insertion of the guiding shell 12 into the assembly shell 22. The assembly slope 221 is matched with the guiding slope 121, which can also play a role in limiting and guiding the insertion of the guiding shell 12. As the guiding slope 121 is in close contact with the assembly slope 221, the guiding shell 12 can be pushed to keep aligned with the assembly shell 22, and the possibility of offset between the guide shell 12 and the assembly shell 22 is reduced.

Referring to FIG. 3, in some embodiments of the present disclosure, a sealing groove 123 for installing a sealing ring (not shown) is provided in the outer side wall of the guiding shell 12. The sealing ring abuts against the inner side wall of the assembly shell 22 to seal a gap between the assembly shell 22 and the guiding shell 12.

Specifically, the sealing groove 123 is arranged around the outer side wall of the guiding shell 12 and located on a lower side of the guiding rib 122. The sealing ring is bonded to the sealing groove 123 with glue, and can be made of rubber with one side protruding out of the sealing groove 123 to abut against the inner side wall of the assembly shell 22.

By arranging the sealing ring, when the guiding shell 12 is inserted into the assembly shell 22, a gap between the guiding shell 12 and the assembly shell 22 can be effectively sealed by the sealing ring, thereby improving the sealing performance between the guiding shell 12 and the assembly shell 22.

In some embodiments of the present disclosure, the first body 11 is integrally formed with a female barrel 112, and the second body 21 is integrally formed with a male barrel 25.

Specifically, the first body 11 is integrally formed with the female barrel 112, meaning that during the manufacturing process of the first plug core 1, the first body 11 including the female barrel 112 is directly formed by injection molding or other molding methods. At this point, the position and installation orientation of the female barrel 112 relative to the first body 11 are fixed. Then, a pin connected to a wire is inserted into the female barrel 112, and a plug cover 113 is provided at one end of the female barrel 112 to serve as a positive or negative electrode of the first plug core 1, thereby completing the production of the first plug core 1. When an operator connects the first plug core 1 to the first device, the orientation and sequence of the female barrel 112 are already determined, then the second plug core 2 can be correspondingly installed. The second plug core 2 is manufactured in a same manner as the first plug core 1 and will not be redundantly described herein.

By integrally forming the first body 11 with the female barrel 112 and integrally forming the second body 21 with the male barrel 25, the connector can be installed by: simply securing the first body 11 to complete the installation of the first plug core 1, and installing the second plug core 2 based on the installation orientation and sequence of the first plug core 1. This effectively simplifies the installation process, reduces installation difficulty, and minimizes the possibility of installation errors, thereby significantly improving installation efficiency of the connector compared with the prior art.

Referring to FIG. 3 and FIG. 4, in some embodiments of the present disclosure, the first plug core 1 is configured to float relative to the first device within a predetermined clearance range, the predetermined clearance is ±3.2 mm.

Specifically, since there is no need to provide separate guiding structures on both sides of the plug cores, the available space for the first body 11 is increased. Accordingly, a slotted hole can be provided in the first body 11 as installation holes for fasteners. A length of the slotted hole is ±3.2 mm. A plurality of slotted holes are provided circumferentially around the first body 11, allowing the first body 11 to float within a ±3.2 mm range. Therefore, the first plug core 1 can be plugged and matched with the second plug core 2 within a larger tolerance range, thereby improving the adaptability of the connector and expanding applicable scenarios of the connector, making the connector suitable for use in various environments. Meanwhile, the slotted hole can also be regular circular holes.

In some embodiments of the present disclosure, both the first body 11 and the second body 21 include a plurality of power terminals 111. Specifically, the first body 11 and the second body 21 can be provided with a plurality of female barrels 112 serving as power terminals 111. For example, two groups of parallel female barrels 112 may be provided, with orange plug covers 113 arranged on the first group to serve as the positive electrodes and black plug covers 113 arranged on the second group to serve as the negative electrodes. This allows the first body 11 to connect with a plurality of power transmission terminals in the first device, and the second body 21 to connect with a plurality of power transmission terminals in the second device, thereby effectively enhancing the adaptability of the connector.

Referring to FIG. 4, in some embodiments of the present disclosure, the second plug core 2 is provided with eccentric mounting holes 24 for receiving screws that connect second plug core to the second device.

Specifically, a cross-section of the second body 21 can be rectangular. In this case, eccentric mounting holes 24 are formed at middle portions on both left and right sides of the second body 21, where a line connecting the two eccentric mounting holes 24 is not parallel to any side edge of the second body 21, so that the two eccentric mounting holes 24 are arranged in a staggered manner. It should be understood that if the cross-section of the second body 21 takes another shape, the position of the eccentric mounting holes 24 can be adjusted accordingly so that an anti-reverse installation effect can be achieved, which is not limited thereto.

By arranging the two eccentric mounting holes 24 in a staggered manner, when the second body 21 is installed, alignment with the corresponding threaded holes in the second device can only be achieved when the second body 21 is installed in the correct orientation. Otherwise, alignment between the eccentric mounting holes 24 and corresponding threaded holes in the second device cannot be achieved, and installation cannot proceed. In this way, reverse installation of the second body 21 can be prevented, allowing operators to quickly determine the correct installation direction of the second body 21, thereby further reducing installation difficulty.

By virtue of the arrangement of the guiding shell and the assembly shell, connection between the first device and the second device can be achieved simply by aligning the first body with the second body and plugging the guiding shell with the assembly shell. Under a guiding action of the guiding shell and the assembly shell, the first plug core can be plugged and matched with the second plug core. Therefore, when the first plug core is plugged with the second plug core, the plugging is quickly completed by using the guiding relationship between the guiding shell and the assembly shell. Moreover, the guiding shell and the assembly shell can be respectively formed by protruding extensions of the first body and the second body themselves, so that the first plug core and the second plug core do not need to be provided with a separate guiding structure. Thereby, the guiding effect of the guiding structure can be effectively ensured, reducing the likelihood of guiding function failure, which is beneficial for ensuring the stable performance of the connector and prolonging its service life.

It is obvious that the above embodiments of the present disclosure are only for the purpose of clearly illustrating the examples provided by the present disclosure and are not intended to limit the embodiments of the present disclosure. For ordinary technicians in the relevant field, various obvious changes, readjustments, and substitutions can be made without departing from the scope of protection of this application. It is not necessary and impossible to exhaustively list all embodiments herein. Any modifications, equivalent substitutions, and improvements made within the spirit and principles of the present disclosure shall be included in the protection scope of the claims of the present disclosure.

What is claimed is:

1. A connector, comprising:
a first plug core configured to connect to a first device, the first plug core comprising:
a first body; and
a guiding shell arranged in the first body, a female barrel for an insertion of a male pin arranged in the guiding shell;
a second plug core configured to connect to a second device, the second plug core comprising:
a second body; and
an assembly shell arranged in the second body and configured to plug and match with the guiding shell, a male barrel for the plugging and matching with the female barrel arranged in the assembly shell.

2. The connector according to claim 1, wherein the guiding shell is formed by protruding from a side of the first body away from the first device and extending in a direction away from the first device; the assembly shell is formed by protruding from a side of the second body away from the second device and extending in a direction away from the second device.

3. The connector according to claim 1, wherein the first plug core is connected to the first device by a plurality of fasteners so as to translate and float relative to the first device.

4. The connector according to claim 1, wherein a first end of the female barrel is arranged through the first body and into the guiding shell, and a second end of the female barrel is disposed in the first device and electrically connected to a circuitry in the first device.

5. The connector according to claim 1, wherein a cross-sectional area of the assembly shell is larger than a cross-sectional area of the guiding shell, a guiding gap for an insertion of the guiding shell is formed between an inner side of the assembly shell and the male barrel, and an inner side wall of the assembly shell is in sliding fit with an outer side wall of the guiding shell.

6. The connector according to claim 1, wherein a cross-section of the assembly shell is rectangular, a cross-section of the guiding shell is rectangular, a length and a width of an inner side of the assembly shell are both greater than a length and a width of an outer side of the guiding shell.

7. The connector according to claim 5, wherein a guiding slope in sliding match with the assembly shell is provided on the outer side wall of the guiding shell.

8. The connector according to claim 5, wherein the outer side wall of the guiding shell is provided with a plurality of grooves, and guiding ribs are formed between any two adjacent grooves.

9. The connector according to claim 5, wherein the inner side wall of the assembly shell is provided with an assembly slope in sliding match with the guiding shell.

10. The connector according to claim 1, wherein a sealing groove for installing a sealing ring is provided in the outer side wall of the guiding shell, and the sealing ring abuts against the inner side wall of the assembly shell to seal a gap between the assembly shell and the guiding shell.

11. The connector according to claim 1, wherein the first body is integrally formed with the female barrel, and the second body is integrally formed with the male barrel.

12. The connector according to claim 1, wherein the first plug core is operable to float relative to the first device within a predetermined clearance range, and the predetermined clearance is ±3.2 mm.

13. The connector according to claim 1, wherein the second plug core is provided with eccentric mounting holes for receiving screws that connect the second plug core to the second device.

14. The connector according to claim 13, wherein a plurality of eccentric mounting holes are provided, the eccentric mounting holes are formed at middle portions on both left and right sides of the second body, a line connecting two of the plurality of eccentric mounting holes is not parallel to any side edge of the second body.

15. The connector according to claim 1, wherein both the first body and the second body comprise a plurality of power terminals.

16. The connector according to claim 3, wherein slotted holes are provided in the first body as installation holes for the fasteners.

17. The connector according to claim 16, wherein a length of the slotted holes is ±3.2 mm.

18. The connector according to claim 16, wherein the slotted holes are provided circumferentially around the first body.

19. The connector according to claim 1, wherein a cross-section of the second body is rectangular.

20. The connector according to claim 10, wherein the sealing ring is bonded to the sealing groove, one side of the sealing ring protruding out of the sealing groove to abut against the inner side wall of the assembly shell.
